(19) United States
(12) Patent Application Publication
(10) Pub. No.: US 2022/0365512 A1
(43) Pub. Date: Nov. 17, 2022

(54) ACCELERATED EVOLUTION AND RESTRUCTURING TECHNIQUES FOR DEVELOPING EVOLVED STRUCTURES

(71) Applicant: UNM RAINFOREST INNOVATIONS, Albuquerque, NM (US)

(72) Inventors: Sang Eon HAN, Albuquerque, NM (US); Sang M. HAN, Albuquerque, NM (US); Bokyung PARK, Albuquerque, NM (US); Bryan KAEHR, Albuquerque, NM (US); Andrew P. SHREVE, Albuquerque, NM (US)

(21) Appl. No.: 17/771,382

(22) PCT Filed: Oct. 23, 2020
(86) PCT No.: PCT/US2020/057153

§ 371 Date: Apr. 22, 2022

Related U.S. Application Data
(60) Provisional application No. 62/925,652, filed on Oct. 24, 2019.
(60) Provisional application No. 63/023,030, filed on May 11, 2020.

(51) Int. Cl. G05B 19/4099

(52) U.S. Cl. CPC G05B 19/4099; G05B 2219/49023

(57) ABSTRACT

A method for developing an evolved structure by artificial evolution includes: obtaining one or more properties of a biological structure; computationally evolve the biological structure to obtain an evolved descriptor; inverse-mapping the evolved description to real space to form an evolved structure design; and constructing the evolved structure. The evolved structure comprises stronger performance across the properties than the biological structure. In an example aspect, a method for constructing an evolved structure includes: removing sericin from a cocoon; forming a first solution from the cocoon with removed sericin; forming a silk fibroin powder from the first solution; dissolving the silk fibroin powder to form a second solution; and electro spinning the second solution based on the evolved structure design.

### CROSS-REFERENCE TO RELATED APPLICATIONS

This application claims priority to U.S. Provisional Patent Application 62/925,652 which was filed on Oct. 24, 2019, and U.S. Provisional Patent Application 63/023,030 which was filed on May 11, 2020, both of which are incorporated herein by reference in their entirety.

### STATEMENT REGARDING FEDERALLY SPONSORED RESEARCH OR DEVELOPMENT

This invention was made with government support under Grant Nos. CHE1231046 and DMR1555290 awarded by the National Science Foundation. The government has certain rights in the invention.

### BACKGROUND

Over a period of hundreds of millions of years of adaptive evolution, the physical properties of life forms evolve and improve. For example, intricate micro and biological nanostructures of life forms may continue to evolve.

Various natural biological nanostructures may be found in life forms in which the nanostructures have a range of optical effects and attributes such as iridescence, camouflage solar rejection, metallic reflection, scattering, etc. The properties evolve and/or strengthen over time to improve the survivability of life forms that possess these structures. Some natural structures may exhibit particularly strong properties. As one example, cocoon silk fibers exhibit strong broadband light scattering with a metallic sheen, which effectively protects pupae from heat emitting from direct sunlight. The strong light scattering properties of a silk fiber may be attributed to its densely packed long fibrillar voids that are aligned along the fiber axis. With a size of hundreds of nanometers in diameter, these fibrillar voids guide light into the fiber axis direction through two-dimensional Anderson localization with a low refractive index contrast of approximately 1.55-1.58. Moreover, silk fibers have a high emissivity over the atmospheric transparency window in mid-infrared (IR). As such, silk fibers may be cooled by radiating heat into outside space. The combined effects of optical and mid-IR properties of silk nanostructures maintain pupae in silk cocoons at a relatively low temperature environment under sunlight.

Another example natural structure that includes strong broadband light scattering by ingenious nanostructures is Cyphochilus white beetle scales. These beetle scales exhibit exceptionally strong light scattering power, providing the beetles with effective camouflage (e.g., among white fungi). The light scattering properties in the beetle scales may be attributed to intricate nanostructures which may differ from silk fibers. The Cyphochilus beetle scale nanostructures are disordered fibrillar networks in which each fibril of a low refractive index of 1.56 has a size of approximately 250 nanometers (nm) in diameter and the fibrils are randomly oriented mostly in the lateral plane. Cyphochilus white beetle scales also exhibit a striking optical effect, where normally incident light is channeled into lateral directions after only a single scattering event. Over a period of time (e.g., millions of years), the nanostructure of white beetle scales (and other life forms) have evolved, improving the light scattering properties and/or other properties of the nanostructure.

### SUMMARY

In one example aspect, a method may include obtaining scattering properties of a biological structure; computationally evolving the biological structure to obtain one or more evolved descriptor; inverse-mapping the one or more evolved descriptors to real space to form an evolved structure design; and constructing the evolved structure.

In one example aspect, a method for developing an evolved structure by artificial evolution includes: obtaining one or more properties of a biological structure; computationally evolve the biological structure to obtain an evolved descriptor; inverse-mapping the one or more evolved descriptors to real space to form an evolved structure design; and constructing the evolved structure.

In one example aspect, a method includes obtaining an evolved structure design based on a biological structure, wherein the evolved structure design is generated based on computationally evolving the biological structure to obtain one or more evolved descriptors; and constructing the evolved structure, the constructing including: removing sericin from a cocoon; forming a first solution from the cocoon with removed sericin; forming a silk fibroin powder from the first solution; dissolving the silk fibroin powder to form a second solution; and electrospinning the second solution based on the evolved structure design.

In one example aspect, an evolved structure developed based on computationally evolving a biological structure includes a film comprising fibers, in which: a mean diameter of the fibers range from approximately 0.25 microns to 1.76 microns and the fibers are randomly oriented in plane directions, a fill fraction of the film ranges from 0.06-0.4, an average emissivity of the film at an atmospheric transparency range of 8-13 microns ranges from 0.89 to 0.97, and an effective transport mean free path across a thickness of the film in the z-direction ranges from 0.8 microns to 50 microns.

### BRIEF DESCRIPTION OF THE DRAWINGS

FIG. 1 illustrates an overview of an example implementation for designing and constructing an evolved structure using accelerated evolution techniques in accordance with aspects of the present disclosure.

FIG. 2 illustrates an example flowchart of a process for designing and constructing an evolved structure using accelerated evolution techniques to mimic or enhance the properties of random structural patterns found in biological structures.

FIG. 3 illustrates an example flowchart of a process for reconstructing natural silk to form an evolved silk structure.

FIG. 4 illustrates details of a regenerated evolved silk structure produced using the techniques described herein.

FIG. 5 illustrates a graph of mean diameter of regenerated evolved silk fibers as a function of fibroin solution concentration.

FIG. 6 illustrates effective transport mean free path and diffusive absorption length as a function of wavelength and mean fiber diameter for different evolved silk structures.

FIG. 7 illustrates an absorptivity/emissivity spectrum of electrospun nanosilk, electrospun microsilk, and raw silk.

FIG. 8 illustrates an experimental set up for acquiring temperature measurements to test the heat insulation properties of regenerated evolved silk structures and results of the temperature measurements.

FIG. 9 illustrates example components of a device that may be used to execute one or more processes of aspects of the present disclosure.

### DETAILED DESCRIPTION

Over a period of time (e.g., millions of years), natural biological structures (e.g., nanostructures) found in lifeforms (e.g., in scales, shells, etc.) have evolved, improving the light scattering properties and/or other properties of the nanostructures. Based on this trend, these nanostructures may continue to evolve and improve over time. Aspects of the present disclosure may include a system and/or method to artificially accelerate the evolution of such naturally occurring biological nanostructures to produce an “evolved material” or “evolved structure” to mimic properties of random structural patterns (e.g., structural patterns found in naturally occurring biological structures). In some embodiments, the evolved structure may include evolved properties (e.g., optical/light scattering properties, heat insulation/dissipation properties, camouflaging properties, and/or other properties) the exceed the performance of biological structures. In some embodiments, aspects of the present disclosure may use of accelerated artificial evolution of biological structures in silico to reveal the physical principles in biological structures, and tailor the structures to form an evolved material for practical applications. In some embodiments, the structural features of the evolved material may be determined using the evolution acceleration techniques described herein, and the evolved material may be fabricated based on the determined structural features. In some embodiments, the evolved material may be constructed using any variety of techniques, such as 3D printing techniques, spray coating, electro spinning, and/or other techniques.

In one example embodiment, optical diffusion theory may be used as part of the accelerated evolution techniques, described herein, to minimize a photon effective transport mean free path, which may be inversely proportional to scattering strength. In some embodiments, the photon effective transport mean free path may be an objective function and element in the accelerated evolution technique. In some embodiments, structural descriptors may be evolved in search of a global optimum point in a wide parameter space.

In some embodiments, the techniques described herein may include obtaining light scattering properties in biological nanostructures (e.g., using optical diffusion approximation, a full solution to a radiative transfer equation, a Monte Carlo simulation, etc.) searching for nanostructures with greater light scattering properties (e.g., lower photon effective transport mean free path values) by performing accelerated artificial evolution to obtain an artificially evolved structure, and imparting light scattering properties of the artificially evolved structures to the infrared region based on the optical scaling principle. In some embodiments, this process may be repeated to iteratively optimize the evolved structure.

In some embodiments, the optimized structures may represent the final stage of an evolutionary process that targets camouflage in a white background or in infrared or any chosen spectrum of interest. That is, aspects of the present disclosure may be used to develop an evolved structure for efficient light scattering to serve as a camouflage in a spectrum of interest. In some embodiments, aspects of the present disclosure perform computational evolution by reduced dimensional descriptors to achieve evolved biostructures.

In one example embodiment, a 3D tomography of a biological structure having high performing light scattering properties (e.g., white beetle scales) may be obtained to identify the underlying physics and structural features that result in the light scattering performance of the scales. Aspects of the present disclosure may computationally evolve the biological structure by its key descriptors (e.g., two-point probability function, lineal path function, chord-length distribution function, and/or surface correlation function) until the objective function (e.g., photon effective transport mean free path) is minimized. A genetic algorithm may be applied for the computational evolution. The evolved descriptors may then be inverse-mapped to real space to construct optimized structures or evolved material.

In some embodiments, constructing the evolved material (e.g., as developed using the accelerated evolution technique or independently of the accelerated evolution technique) may involve 3D printing, spray coating, melt blowing, and/or electrospinning. For example, structural features from the evolved material may be input into a 3D printing system. As one illustrative example, using 3D-direct-write biopolymers with high resolution (e.g., approximately 100 nm), a scaffold in a 3D printing system may be infiltrated with silicon dioxide to preserve the 3D printed structure in an inorganic form. Since the inverse-mapping may yield multiple constructs, new materials may be introduced (e.g., polyethylene and silicon dioxide) and synthetic paths may be used to create structures that share the same optimized descriptors.

The 3D constructs of fully evolved structures may be characterized by their optical properties. In some embodiments, an absorption band may be determined by the intrinsic material absorption coefficient, while the light scattering reflection may be maximized in spectral regions in which the absorption coefficient is negligible. In some embodiments, tailored evolutionary constraints may be applied to achieve spectrally separated absorption and reflection in desired parts of the electromagnetic spectrum. In some embodiments, the present invention may use 3D printing to print the evolved structures or to create the exact inorganic framework by shape-preserved replication of an organic template.

In some embodiments, aspects of the present disclosure may also include a system and/or method to regenerate natural silk using an electrospinning process to construct the evolved structure in the form of a fibrous silk film in which the regenerated silk may exhibit properties similar to a biological structure (e.g., white beet scales, or other type of biological structure). For example, silk fibroin powder may be prepared and used in an electrospinning process to construct an evolved material in the form of a synthetic “microsilk” or “nanosilk” having significantly higher light scattering performance than raw silk. In some embodiments, the electrospun silks may include structural characteristics similar to those of Cyphochilus white beetle scales, but with greater optical scattering performance. In some embodiments, reconstructing of natural silk may include removing sericin from white silk cocoons, forming a solvent and a solution having the white silk cocoons in which the sericin was removed, dialyzing first solution; and filtering, drying, and grinding the solution to produce a silk fibroin powder. In some embodiments, the silk fibroin powder in an acid may dissolved to form a second solution, and the second solution may be electrospun to produce a film comprising regenerated silk fibroin. In some embodiments, fiber diameter, fill fraction, and/or fiber in-plane orientation randomness may be optimized to improve light scattering properties of the fibrous silk film.

In some embodiments, aspects of the present disclosure may be used to develop an evolved material having a variety of improved material properties, such as ultra light-weight mechanical strength, ultrahigh thermal conductivity, super-hydrophobicity., etc. The improved scattering of light, sound, and/or heatwaves may extend to diverse areas of technology including solar rejection, soundproofing, thermal insulation, and/or other technological areas (e.g., clothing, manufacturing, object or vehicle coating, etc.).

Certain embodiments of the disclosure will hereafter be described with reference to the accompanying drawings, wherein like reference numerals denote like elements. It should be understood, however, that the accompanying drawings illustrate only the various implementations described herein and are not meant to limit the scope of various technologies described herein. The drawings show and describe various embodiments of the current disclosure.

Embodiments of the disclosure may include a system, a method, and/or a computer program product at any possible technical detail level of integration. The computer program product may include a computer readable storage medium (or media) having computer readable program instructions thereon for causing a processor to carry out aspects of the present disclosure.

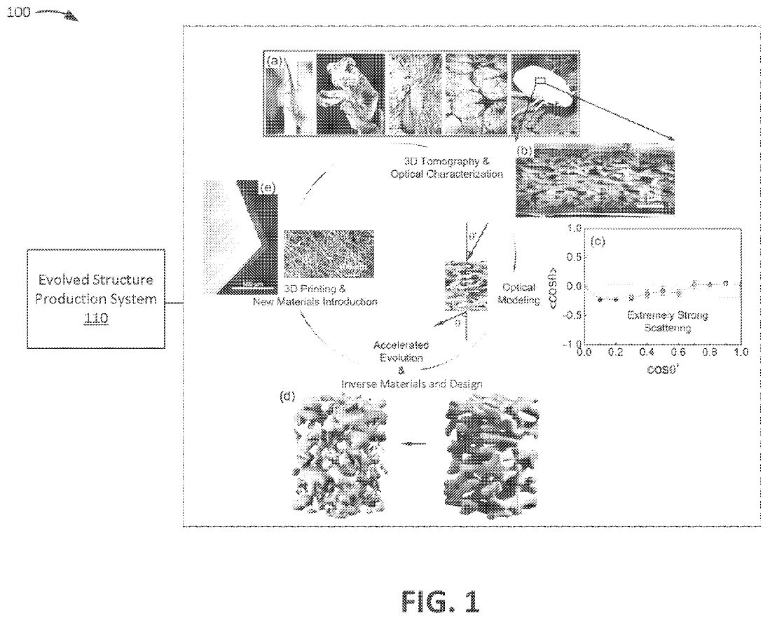

FIG. 1 illustrates an overview of an example implementation for designing and constructing an evolved structure using accelerated evolution techniques in accordance with aspects of the present disclosure. In some embodiments, an evolved structure production system 110 may include a computing system, printing system, and/or manufacturing system that executes one or more processes described herein for designing and constructing an evolved structure using accelerated evolution techniques. In some embodiments, the evolved structure production system 110 may obtain information identifying priorities of biological structures found in nature (e.g., white beetle scales or other biological structures exhibiting desirable properties). Section (a) of FIG. 1 illustrates such properties of biological structures found in nature (e.g., “super” properties, such as super-adhesion, camouflage, iridescence, super-hydrophobicity, and/or super-scattering). In some embodiments, the evolved structure production system 110 may be used to generate a 3D visualization of a desired structure such as micro and nanostructures resembling those biological structures found in nature (e.g., as illustrated in section (b) of FIG. 1. Section (b) of FIG. 1 further illustrates that the 3D tomography of the biological structure reveals that fibrils of multiple length scales are anisotropically interlaced and packed in a compact volume. In some embodiments, the evolved structure production system 110 may perform optical and computational modeling of the physical properties of the biological structures (which may include optical diffusion approximation computing a full solution to a radiative transfer equation, a Monte Carlo simulation, etc.). As shown in section (c) of FIG. 1, the computation modeling, when applied to the complex biological structures (e.g., beetle scale), reveals that the visible light would scatter sideways after one scattering event.

As further described herein, the evolved structure production system 110 may perform accelerated evolution by key descriptors and inverse materials design. For example, the evolved structure production system 110 may computationally evolve the biological structure model by its key descriptors (e.g., two-point probability function, lineal path function, chord-length distribution function, and/or surface correlation function) until the objective function (e.g., photon effective transport mean free path) is minimized. In some embodiments, a genetic algorithm may be applied for the computational evolution. The evolved descriptors may then be inverse-mapped to real space to construct an optimized or evolved structure (e.g., as shown in section (d) of FIG. 1). In some embodiments, the evolved structure production system 110 may construct the evolved structure using, for example, a 3D printing process. As one example, using 3D-direct-write biopolymers with high resolution (e.g., approximately 100 nm), a scaffold in the 3D printing system may be infiltrated with silicon dioxide to preserve the 3D-printed structure in an inorganic form. Since the inverse-mapping may yield multiple constructs, new materials may be introduced (e.g., polyethylene and silicon dioxide) and synthetic paths can be used to create structures that share the same optimized descriptors (e.g., as shown in section (e) of FIG. 1). In some embodiments, the constructed evolved structure may be further tailored by applying evolutionary constraints to achieve spectrally separated absorption and reflection in desired parts of the electromagnetic spectrum.

### Example Design Process

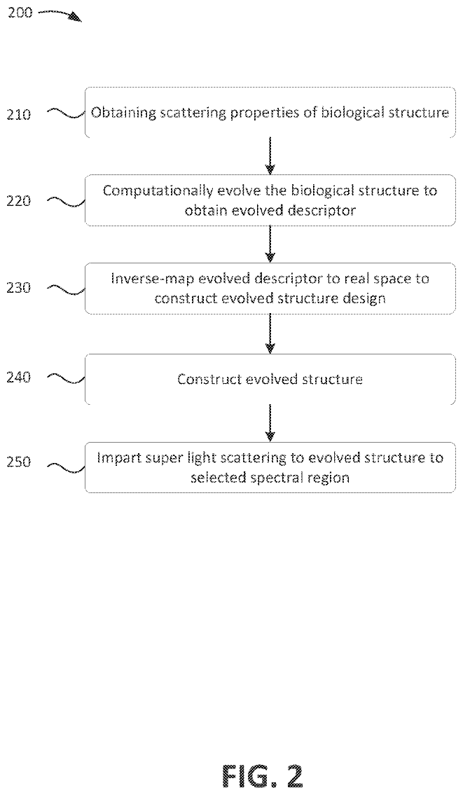

FIG. 2 illustrates an example flowchart of a process for designing and constructing an evolved structure using accelerated evolution techniques to mimic or enhance the properties of random structural patterns found in biological structures. As noted herein, the flowchart illustrates the architecture, functionality, and operation of possible implementations of systems, methods, and computer program products according to various embodiments of the present disclosure.

As shown in FIG. 2, The process 200 may include obtaining scattering properties of a biological structure (block 210). For example, the evolved structure production system 110 may obtain the scattering properties of a biological structure (e.g., a white beetle scale or other biological structure) by one or more techniques, such as optical diffusion approximation, computing a full solution to a radiative transfer equation, a Monte Carlo simulation, etc. In some embodiments, the evolved structure production system 110 may form an optical model of the scattering properties by performing the optical diffusion approximation (e.g., as shown in sections (b) and (c) of FIG. 1).

The process 200 also may include computationally evolving the biological structure to obtain an evolved descriptor (block 220). For example, the evolved structure production system 110 may computationally evolves the biological structure by its key descriptors (e.g., two-point probability function, lineal path function, chord-length distribution function, and/or surface correlation function) until the objective function (e.g., photon effective transport mean free path) is minimized. In some embodiments, a genetic algorithm may be applied for the computational evolution.

The process 200 further may include inverse-mapping the evolved descriptor to a real space to construct evolved structure design (block 230). For example, the evolved structure production system 110 may inverse-map the evolved descriptor (e.g., as shown in section (d) of FIG. 1).

The process 200 also may include constructing the evolved structure (block 240). For example, the evolved structure production system 110 may construct the evolved structure from the evolved structure design (e.g., from block 230). In some embodiments, the evolved structure may be constructed using 3D printing techniques. Additionally, or alternatively, the evolved structure may be constructed using electrospinning, melt blowing, and/or spray coating techniques. Since the inverse-mapping (e.g., from block 230) may yield multiple constructs rather than a unique solution, new materials may be introduced in the 3D printing process (e.g., polyethylene and silicon dioxide) and synthetic paths may be used to create structures that share the same optimized descriptors. In some embodiments, the evolved structure may include fibrillar network structures having a fibril diameter ranging from approximately 0.2 μm to 20 μm.

The process 200 further may include imparting super light scattering to the evolved structure to a selected spectral region (block 250). For example, the evolved structure production system 110 may impart super light scattering to the evolved structure to a selected spectral region, such as the infrared region (e.g., to optimize the light scattering of the evolved structure for the selected spectral region to improve camouflaging at the selected spectral region). In this way, the evolved structure may be tailored to improve camouflaging within any selected spectral region.

In some embodiments, the process 200 may be used to design and construct an evolved structure based on other types of properties other than light scattering properties. Thus, at block 210, the evolved structure production system 110 may obtain a different property (or group of properties) associated with a biological structure, and at block 220, computationally evolve the biological structure to obtain an evolved descriptor associated with the property (or group of properties). In this way, the constructed evolved structure may exhibit stronger or more evolved properties than those found in the biological structures.

### Example Construction Process

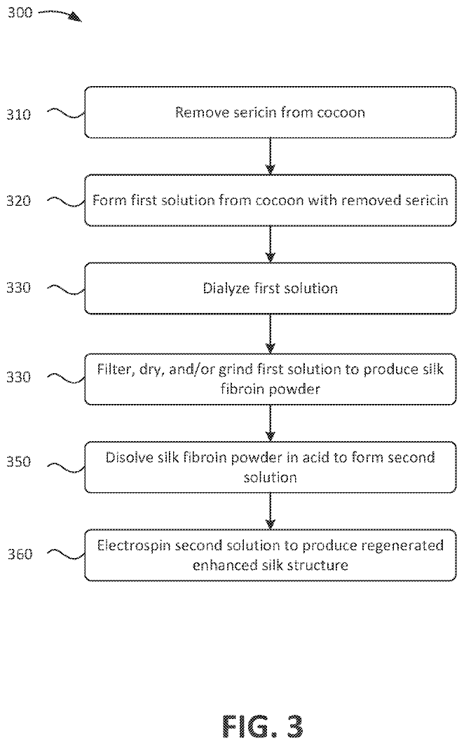

FIG. 3 illustrates an example flowchart of a process for reconstructing natural silk to form an evolved silk structure. As noted herein, the flowchart illustrates the architecture, functionality, and operation of possible implementations of systems, methods, and computer program products according to various embodiments of the present disclosure. In some embodiments, the process of FIG. 3 may be performed independently or in conjunction with the process 200 described in FIG. 2. For example, the process 300 of FIG. 3 may be used to construct an evolved structure design generated using the process 200 described in FIG. 2. That is, in some embodiments, the process 300 of FIG. 3 may be sub-steps of block 240 of process 200 in FIG. 2.

As shown in FIG. 3, the process 300 may include removing sericin from a cocoon (block 310). For example, sericin may be removed from a cocoon (e.g., Bombyx mori (Geumokjam) white silk cocoons) using a degumming process, which may include process block 320 and 330 as discussed below.

The process 300 also may include forming a first solution including the cocoon with removed sericin (block 320). For example, the degumming process from block 310 may continue in which a solution (e.g., aqueous solution of 0.2% w/v sodium carbonate and 0.3% w/v sodium oleate) may be formed and heated (e.g., at 105° C.). The cocoon may be heated in the solution for a period of time (e.g., 90 minutes) to remove sericin from the cocoons. The degummed silk cocoon, which is comprised primarily of fibroin, may be rinsed with distilled water (at 100° C. for 150 seconds) to remove residual sericin in the silk cocoons. After further rinsing with cold distilled water, the silk cocoon may be dried (at 80° C. for a day). The degummed silk cocoon may be dissolved (e.g., at a liquor ratio of 1:20 in a CaCl₂/H₂O/EtOH (1/8/2 molar ratio) mixture solvent at 85° C. for 30 minutes) to form the first solution.

The process 300 may further include dialyzing the first solution (block 330). For example, to remove CaCl₂ from the dissolved silk fibroin, the first solution may be placed in a tube of a cellulose membrane and dialyzed (e.g., for 4 days) by circulating distilled water around the tube. The membrane was impenetrable to fibroin of molecular weight over 12,000-14,000.

The process 300 may also include filtering, drying, and/or grinding the first solution to produce a silk fibroin powder (block 340). For example, the dialyzed silk fibroin solution may be filtered through a polyethylene porous membrane to remove any extraneous dirt. The filtered solution may be dried and ground into a silk fibroin powder.

The process 300 further may include dissolving the silk fibroin powder in acid to form a second solution (block 350). For example, regenerated silk fibroin powders produced at block 340) may be dissolved in formic acid (e.g., for 3 hours at a concentration of 8-15 wt %) and filtered through a polyethylene porous membrane.

The process 300 also may include electrospinning the second solution to produce a regenerated evolved silk structure (block 360). For example, the fibroin solution (e.g., from block 350) may be loaded into a syringe (e.g., with a 21-gauge stainless steel needle with inner diameter of 0.495 mm) for electrospinning. A voltage of, for example, 22.5 kV, may be applied to the needle and a drum-shaped collector may be electrically grounded. Distance between the needle tip to the collector surface may be set to 15 cm. The drum collector may be rotated about its axis at (e.g., 34 rpm). The regenerated silk fibroin at each solution concentration may be electrospun onto the collector (e.g., for 8 hours).

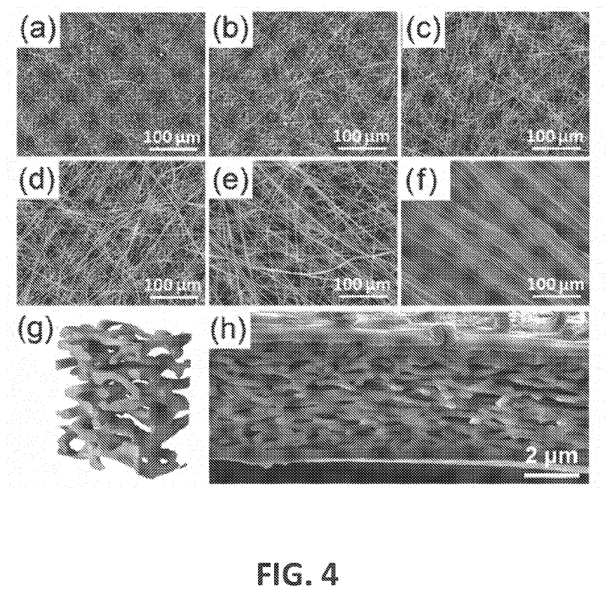

In one or more alternative embodiments, a regenerated evolved silk structure may be formed from raw silk fibrous films of varying thicknesses (e.g., from 75 μm to 570 μm) may be prepared from Bombyx mori white silk cocoons. To prepare the films, the silk cocoons may be immersed in distilled water (e.g., at 85° C. for an hour) to render the fibers more flexible by swelling sericin in them. The silk cocoons may be transferred into a water bath (e.g., at 50° C.). An end of a silk fiber in each cocoon may be attached to a cylindrical bobbin after passing through a slit. In the fiber winding system, the bobbin may be rotated about its axis to wind the fiber on it at an appropriate speed, and the slit oscillated parallel to the bobbin axis at an appropriate speed. The bobbin and slit speeds may determine the winding angle. After the silk fiber is wound on the bobbin into a layer, the layer may be cut (e.g., into 8 pieces). The pieces may be stacked with each successive layer rotated by, for example, 90°, in the plane. The layer rotation in stacking approximates the random orientation of silk fibers in directions parallel to the surface of cocoon shells. After the stacking, distilled water may be sprayed onto the top layer to allow the water to penetrate into the underneath layers (e.g., for 5 minutes). The stacked layers may be subsequently hot pressed (e.g., at 200° C. for 20 seconds). The resulting structure may include an evolved structure including a fibrous silk film with fibers randomly oriented in plane directions (as further shown in FIG. 4). In some embodiments, the evolved structure may have a film fraction ranging from 0.06-0.4 compared to the fill fraction of white beetle scales of 0.30-0.32. In some embodiments, optimizing the fill fraction in the electrospun evolved structure may further improve optical scattering.

In some embodiments, other processes and/or materials may be implemented to construct the evolved structure. For example, the resulting structure may include an evolved film constructed from a polymer material, such as polypropylene, nylon, polystyrene, polylactic acid, polyethylene terephthalate, polyethylene, polycarbonate, polyphenylene ether, or the like.

### Example Evolved Structures and Attributes

FIG. 4 illustrates details of example regenerated evolved silk structures designed and/or produced using the techniques described herein (e.g., using the processes 200 of FIG. 2 and 300 of FIG. 3). For example, sections (a) through (e) of FIG. 4 illustrate top views of scanning electron microscope (SEM) images of different regenerated evolved silk structures having fibers with different mean diameters in comparison with raw silk shown in section (f) and a 3D rendered image of a white beet scale (shown in section (g)) and cross sectional SEM image of a white beetle scale (shown in section (h)). As described herein, the different evolved silk structures (e.g., structures (a) through (e)) may be produced with different diameters based on different silk fibroin concentrations. Structure (a) may be referred to as “nanosilk” with a mean diameter of approximately than 0.25 microns and structure (e) may be referred to as “microsilk” with a mean diameter of approximately 1.76 microns. As further shown in FIG. 4, the fibers are randomly oriented in plane directions.

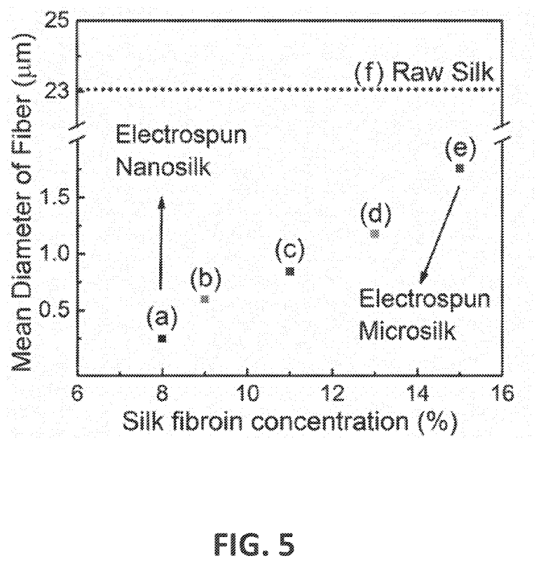

FIG. 5 illustrates a graph of mean diameter of regenerated evolved silk fibers as a function of fibroin solution concentration for the regenerated evolved silk structures shown in sections (a) through (e) of FIG. 4 in comparison with raw silk. As shown in FIG. 5 silk fibroin concentration is proportional to the mean diameter. In some embodiments, the mean diameter of the regenerated evolved silk fibers may range from approximately 0.25 microns to 1.76 microns.

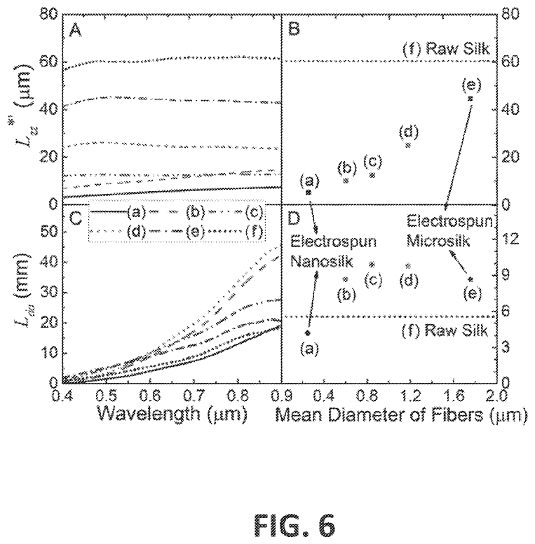

FIG. 6 illustrates effective transport mean free path and diffusive absorption length as a function of wavelength and mean fiber diameter for the different evolved silk structures (a) through (e) in FIG. 4. More specifically, section A FIG. 6 illustrates effective transport mean free path L*_{zz}′ (e.g., across a thickness of the silk structures in a Z direction) as a function of wavelength. Section B of FIG. 6 illustrates effective transport mean free path as a function of different mean diameters of different regenerated evolved silk structures. Sections C of FIG. 6 illustrates diffusive absorption length (L_{da}) as a function of wavelength. Section D FIG. 6 illustrates diffusive absorption length as a function of different mean diameters of different regenerated evolved silk structures. As shown in sections A and B, the evolved silk structures (a) through (e) provide lower (e.g., improved) effective transport mean free path than raw silk over various wavelengths and mean diameters. As shown in section C, evolved silk structures (b) through (e) exhibit greater diffusive absorption lengths over different wavelengths than raw silk, and evolved silk structure (a) exhibits nearly similar diffusive absorption lengths over different wavelengths as raw silk. As shown in section D, evolved silk structures (b) through (e) exhibit greater diffusive absorption lengths over different mean diameters than raw silk, and evolved silk structure (a) exhibits nearly slightly lower diffusive absorption lengths over different wavelengths as raw silk. As shown in section B, the evolved silk structures may have an effective transport mean free path L*_{zz}′ ranging from 0.8 microns to 50 microns.

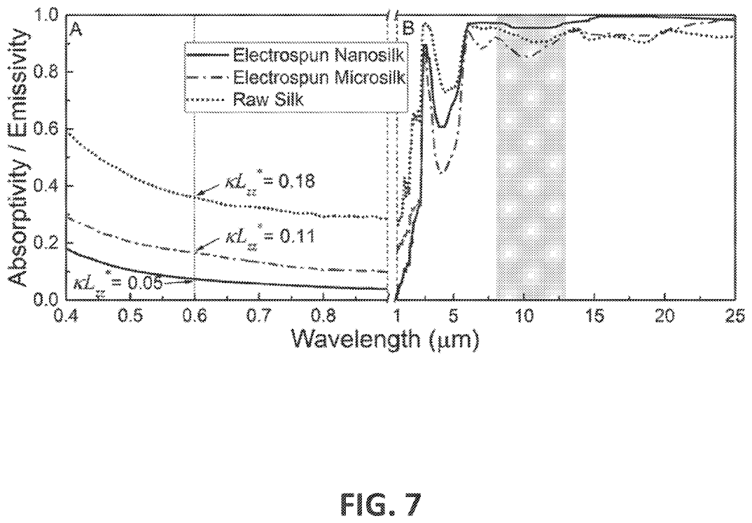

FIG. 7 illustrates an absorptivity/emissivity spectrum of electrospun nanosilk, electrospun microsilk, and raw silk at a thickness of 420 μm placed on a black substrate over the (A) visible and (B) mid-IR wavelengths. κL_{zz}* values at A=0.6 μm for the three samples are displayed in (A). Atmospheric transparency window is highlighted in (B). As shown in FIG. 7, an average emissivity of the electrospun (evolved) microsilk and nanosilk at an atmospheric transparency range of 8-13 microns range from 0.89 to 0.97.

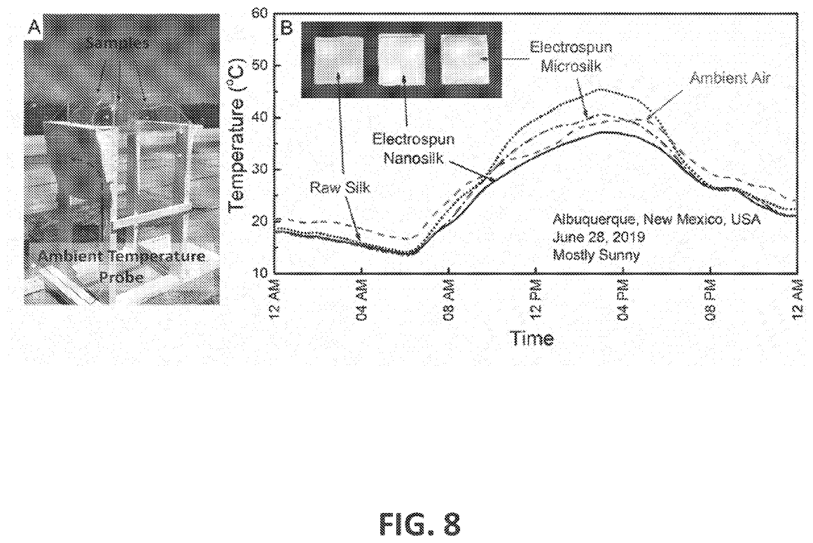

FIG. 8 illustrates an experimental set up for acquiring temperature measurements to test the heat insulation properties of regenerated evolved silk structures and results of the temperature measurements. More specifically, section A of FIG. 8 illustrates outdoor experimental setup for temperature measurements. Section B of FIG. 8 illustrates measured temperature variation over a day for regenerated evolved nanosilk, regenerated evolved microsilk, raw silk, and ambient air. As shown in FIG. 8, the regenerated evolved nanosilk and microsilk outperformed raw silk with respect to heat insulation and heat rejection.

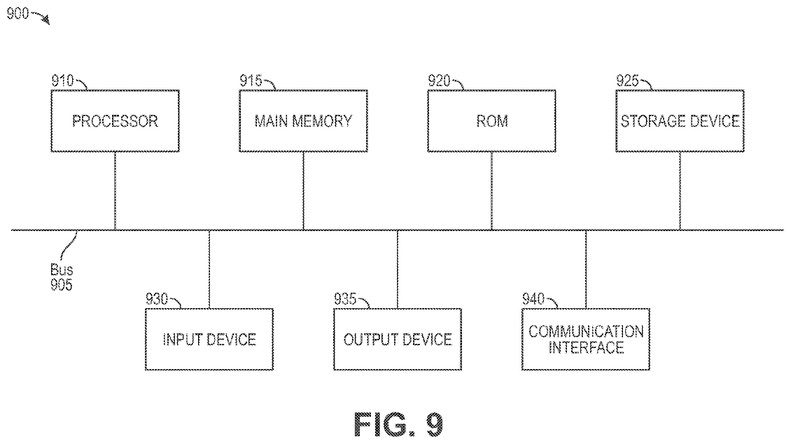

FIG. 9 illustrates example components of a device 900 that may be used to execute one or more processes of aspects of the present disclosure. Device 900 may correspond the evolved structure production system 110. The evolved structure production system 110 may include one or more devices 900 and/or one or more components of device 900.

As shown in FIG. 9, device 900 may include a bus 905, a processor 910, a main memory 915, a read only memory (ROM) 920, a storage device 925, an input device 930, an output device 935, and a communication interface 940.

Bus 905 may include a path that permits communication among the components of device 900. Processor 910 may include a processor, a microprocessor, an application specific integrated circuit (ASIC), a field programmable gate array (FPGA), or another type of processor that interprets and executes instructions. Main memory 915 may include a random access memory (RAM) or another type of dynamic storage device that stores information or instructions for execution by processor 910. ROM 920 may include a ROM device or another type of static storage device that stores static information or instructions for use by processor 910. Storage device 925 may include a magnetic storage medium, such as a hard disk drive, or a removable memory, such as a flash memory.

Input device 930 may include a component that permits an operator to input information to device 900, such as a control button, a keyboard, a keypad, or another type of input device. Output device 935 may include a component that outputs information to the operator, such as a light emitting diode (LED), a display, or another type of output device. Communication interface 940 may include any transceiver-like component that enables device 900 to communicate with other devices or networks. In some implementations, communication interface 940 may include a wireless interface, a wired interface, or a combination of a wireless interface and a wired interface. In embodiments, communication interface 940 may receive computer readable program instructions from a network and may forward the computer readable program instructions for storage in a computer readable storage medium (e.g., storage device 925).

Device 900 may perform certain operations, as described in detail below. Device 900 may perform these operations in response to processor 910 executing software instructions contained in a computer-readable medium, such as main memory 915. A computer-readable medium may be defined as a non-transitory memory device and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. A memory device may include memory space within a single physical storage device or memory space spread across multiple physical storage devices.

The software instructions may be read into main memory 915 from another computer-readable medium, such as storage device 925, or from another device via communication interface 940. The software instructions contained in main memory 915 may direct processor 910 to perform processes that will be described in greater detail herein. Alternatively, hardwired circuitry may be used in place of or in combination with software instructions to implement processes described herein. Thus, implementations described herein are not limited to any specific combination of hardware circuitry and software.

In some implementations, device 900 may include additional components, fewer components, different components, or differently arranged components than are shown in FIG. 9.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may include a system, a method, and/or a computer program product at any possible technical detail level of integration. The computer program product may include a computer readable storage medium (or media) having computer readable program instructions thereon for causing a processor to carry out or execute aspects and/or processes of the present disclosure.

In embodiments, the computer readable program instructions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on a user's computer, partly on the user's computer, as a stand-alone software package, partly on the user's computer and partly on a remote computer or entirely on the remote computer or server.

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In embodiments, a service provider could offer to perform the processes described herein. In this case, the service provider can create, maintain, deploy, support, etc., the computer infrastructure that performs the process steps of the disclosure for one or more customers. These customers may be, for example, any business that uses technology. In return, the service provider can receive payment from the customer(s) under a subscription and/or fee agreement and/or the service provider can receive payment from the sale of advertising content to one or more third parties.

The foregoing description provides illustration and description, but is not intended to be exhaustive or to limit the possible implementations to the precise form disclosed. Modifications and variations are possible in light of the above disclosure or may be acquired from practice of the implementations.

It will be apparent that different examples of the description provided above may be implemented in many different forms of software, firmware, and hardware in the implementations illustrated in the figures. The actual software code or specialized control hardware used to implement these examples is not limiting of the implementations. Thus, the operation and behavior of these examples were described without reference to the specific software code—it being understood that software and control hardware can be designed to implement these examples based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While the present disclosure has been disclosed with respect to a limited number of embodiments, those skilled in the art, having the benefit of this disclosure, will appreciate numerous modifications and variations there from. It is intended that the appended claims cover such modifications and variations as fall within the true spirit and scope of the disclosure.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

1. A method comprising:
obtaining scattering properties of a biological structure;
computationally evolving the biological structure to obtain one or more evolved descriptors;
inverse-mapping the one or more evolved descriptors to real space to form an evolved structure design; and
constructing the evolved structure.

2. The method of claim 1, wherein the constructing the evolved structure comprises constructing the evolved structure using at least one of:
melt blowing;
spray coating; and
electro spinning.

3. The method of claim 1, wherein the obtaining the scattering properties comprises at least one of:
optical diffusion approximation;
a full solution to a radiative transfer equation; and
Monte Carlo simulation.

4. The method of claim 1, further comprising imparting super light scattering to the evolved structure to a selected spectral region.

5. The method of claim 1, wherein the biological structure is a white beetle scale.

6. The method of claim 1, wherein the evolved structure comprises fibrillar network structures having a fibril diameter ranging from approximately 0.2 μm to 20 μm.

7. The method of claim 1, wherein the evolved structure comprises stronger scattering performance than the biological structure.

8. The method of claim 1, wherein the one or more evolved descriptors include at least one of:
two-point probability function;
lineal-path function;
chord-length distribution function; and
surface correlation function.

9. A method comprising:
obtaining one or more properties of a biological structure;
computationally evolving the biological structure to obtain one or more evolved descriptors;
inverse-mapping the one or more evolved descriptors to real space to form an evolved structure design; and
constructing the evolved structure.

10. The method of claim 9, wherein the constructing the evolved structure comprises constructing the evolved structure using at least one selected from the group consisting of:
melt blowing;
spray coating; and
electro spinning.

11. The method of claim 9, wherein the obtaining the one or more properties comprises obtaining the one or more properties using optical diffusion approximation.

12. The method of claim 9, further comprising imparting super light scattering to the evolved structure to a selected spectral region.

13. The method of claim 9, wherein the biological structure is a white beetle scale.

14. The method of claim 9, wherein the evolved structure comprises fibrillar network structures having a fibril diameter ranging from approximately 0.2 μm to 20 μm.

15. The method of claim 9, wherein the one or more properties comprises at least one of:
light scattering properties,
mechanical strength,
thermal conductivity, and
hydrophobicity,
wherein the one or more properties of the evolved structure have stronger performance than the biological structure.

16. The method of claim 9, wherein the one or more evolved descriptors include at least one of:
two-point probability function;
lineal-path function;
chord-length distribution function; and
surface correlation function.

17. A method comprising:
obtaining an evolved structure design based on a biological structure, wherein the evolved structure design is generated based on computationally evolving the biological structure to obtain one or more evolved descriptors; and
constructing the evolved structure, the constructing comprising:
removing sericin from a cocoon;
forming a first solution from the cocoon with removed sericin;
forming a silk fibroin powder from the first solution;
dissolving the silk fibroin powder to form a second solution; and
electrospinning the second solution based on the evolved structure design.

18. The method of claim 17, further comprising dialyzing the first solution prior to forming the silk fibroin powder.

19. The method of claim 17, wherein fibers of the evolved structure have a mean diameter of approximately 0.2 microns to 20 microns.

20. An evolved structure developed based on computationally evolving a biological structure comprising:
a film comprising fibers, wherein:
a mean diameter of the fibers ranges from approximately 0.2 microns to 20 microns and the fibers are randomly oriented in plane directions,
a fill fraction of the film ranges from 0.06-0.4,
an average emissivity of the film at an atmospheric transparency range of 8-13 microns ranges from 0.89 to 0.97,
an effective transport mean free path across a thickness of the film in the z-direction ranges from 0.8 microns to 50 microns and.
wherein the evolved structure based on computationally evolving the biological structure comprises an enhanced property compared to the biological structure.

21. The evolved structure of claim 20, wherein the film comprises a regenerated electrospun silk.

22. The evolved structure of claim 20, wherein the film comprises a polymer comprising at least one of:
polypropylene,
nylon,
polystyrene,
polylactic acid,
polyethylene terephthalate,
polyethylene,
polycarbonate, and
polyphenylene ether.
